(19) United States
(12) Patent Application Publication
(10) Pub. No.: US 2012/0200792 A1
(43) Pub. Date: Aug. 9, 2012

(54) PHASE SHIFT PLATE AND STEREOSCOPIC DISPLAYING APPARATUS HAVING THE SAME

(75) Inventor: Yoshiyuki Nishida, Niigata (JP)

(73) Assignee: ARISAWA MFG. CO., LTD., Niigata (JP)

(21) Appl. No.: 13/198,678

(22) Filed: Aug. 4, 2011

(30) Foreign Application Priority Data
Oct. 6, 2010 (JP) 2010-226899
Dec. 10, 2010 (JP) 2010-276375
Aug. 4, 2011 (JP) 2011-170702

(51) Int. Cl. G02F 1/1335

(52) U.S. Cl. 349/15; 349/122

(57) ABSTRACT

A phase shift plate comprising a transparent substrate; an orientation layer that is formed on one surface of the substrate and that includes anisotropic polymers with orientation direction patterns arranged periodically along a primary surface of the substrate; and a liquid crystal layer that includes liquid crystals that are periodically oriented according to the orientation direction of the orientation layer. The transparent substrate is formed by a cyclic olefin copolymer made of a norbornene and ethylene copolymer.

### BACKGROUND

1. Technical Field

The present invention relates to a phase shift plate and a stereoscopic image display apparatus that uses the phase shift plate.

2. Related Art

Japanese Patent Application Publication No. 2005-91834 describes a stereoscopic image display apparatus that includes an image output section for outputting image light, a polarizing plate, and a phase shift plate.

The phase shift plate used in a conventional stereoscopic image display apparatus usually has a phase shift function provided on the main surface of a glass substrate. However, a phase shift plate using a glass substrate has a problem that realizing excellent dimensional stability results in the phase shift plate and glass substrate being heavy and difficult to handle. In order to solve these problems, phase shift plates are being developed that are made from a film substrate using a film made of triacetylcellulose or polycarbonate as a base material. However, the resulting phase shift plates have problems with dimensional stability, thermal endurance, and adhesion, which were not problems in the phase shift plates made from the glass substrates.

### SUMMARY

Therefore, it is an object of an aspect of the innovations herein to provide a phase shift plate and a stereoscopic image display apparatus that uses the phase shift plate, which are capable of overcoming the above drawbacks accompanying the related art. The above and other objects can be achieved by combinations described in the independent claims. The dependent claims define further advantageous and exemplary combinations of the innovations herein. According to a first aspect related to the innovations herein, provided is a phase shift plate comprising a transparent substrate formed by a cyclic olefin copolymer made of a norbornene and ethylene copolymer; an orientation layer that is formed on one surface of the substrate and that includes anisotropic polymers with orientation direction patterns arranged periodically along a primary surface of the substrate; and a liquid crystal layer that includes liquid crystals that are periodically oriented according to the orientation direction of the orientation layer. Also provided is a stereoscopic image display apparatus comprising the phase shift plate.

The summary clause does not necessarily describe all necessary features of the embodiments of the present invention. The present invention may also be a sub-combination of the features described above.

### BRIEF DESCRIPTION OF THE DRAWINGS

FIG. 1 is an exploded perspective view of a stereoscopic image display apparatus.

FIG. 2 is a cross-sectional view of the stereoscopic image display apparatus.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

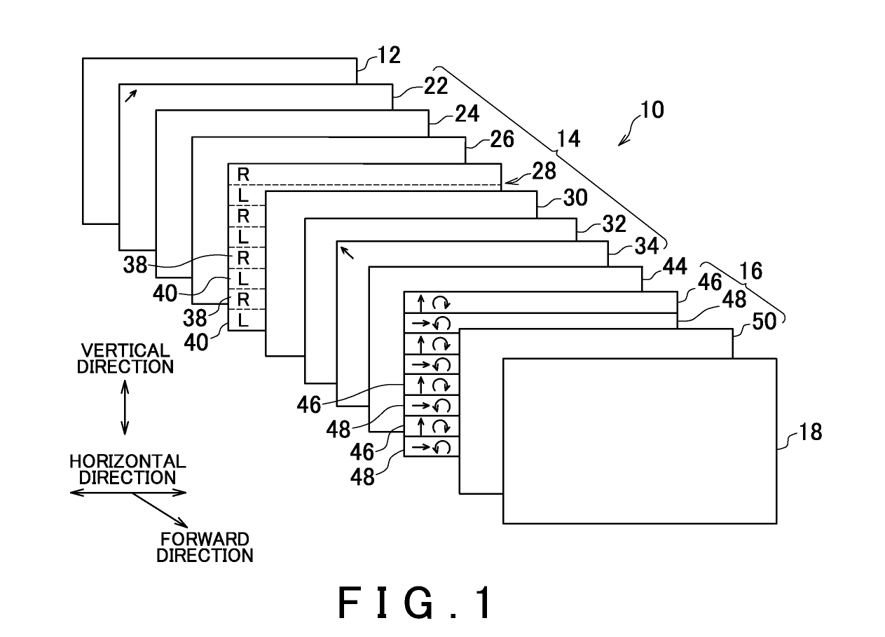

FIG. 1 is an exploded perspective view of a stereoscopic image display apparatus. As shown by the arrows in FIG. 1, the direction in which the image is emitted, which is toward the position of the user, is a forward direction of the stereoscopic image display apparatus. As shown in FIG. 1, the stereoscopic image display apparatus 10 includes a light source 12, an image output section 14, an adhesive layer 44 that is an example of a second adhesive layer, a phase shift plate 16, and an anti-reflection film 18.

The light source 12 emits polarized white light with a substantially uniform intensity in a plane. The light source 12 is arranged at the absolute rear of the stereoscopic image display apparatus 10, as seen from the position of the user. The light source 12 can be a light source resulting from the combination of a diffusion plate and a cold cathode fluorescent lamp (CCFL) or from the combination of a Fresnel lens and a light emitting diode (LED).

The image output section 14 is arranged in front of the light source 12. The image output section 14 outputs an image using light from the light source 12. The image output section 14 includes a polarizing plate 22, an adhesive layer 24, a support substrate 26, an optical element 28, a support substrate 30, an adhesive layer 32, and a polarizing plate 34.

The polarizing plate 22 is arranged between the light source 12 and the support substrate 26. The polarizing plate 22 is formed of a resin containing polyvinyl alcohol (PVA). The material for forming the polarizing plate 22 may be changed as needed. The polarizing plate 22 is affixed to the rear surface of the optical element 28 by the adhesive layer 24. The polarizing plate 22 includes a transmission axis inclined 45° from the horizontal direction and an absorption axis that is orthogonal to the transmission axis. As a result, among the non-polarized light emitted from the light source 12 and incident to the polarizing plate 22, the component with an oscillation direction that is parallel to the transmission axis of the polarizing plate 22 is transmitted and the component with an oscillation direction that is parallel to the absorption axis is absorbed, and thereby blocked. Therefore, the light emitted from the polarizing plate 22 is linearly polarized light having the transmission axis of the polarizing plate 22 as the polarization axis.

The adhesive layer 24 is provided substantially uniformly on the entire rear surface of the support substrate 26. The adhesive layer 24 can be realized using an acrylic adhesive agent. The adhesive layer 24 affixes the polarizing plate 22 to the rear surface of the support substrate 26.

The support substrate 26 is arranged between the polarizing plate 22 and the optical element 28. The support substrate 26 can be realized by a transparent glass plate. Instead of using a glass plate, the support substrate 26 can be a transparent composite sheet that uses a transparent composite material including a glass fabric and a transparent resin. As a result, the stereoscopic image display apparatus 10 can be light-weight and have good flexibility. The rear surface of the support substrate 26 supports the polarizing plate 22 via the adhesive layer 24.

The optical element 28 is arranged and supported between the support substrate 26 and the support substrate 30. As shown by the letters R and L in FIG. 1, the optical element 28 includes right-eye image generating sections 38 that generate a right-eye image and left-eye image generating sections 40 that generate a left-eye image. The right-eye image generating sections 38 and the left-eye image generating sections 40 may each be formed as strips that extend in the horizontal direction. The right-eye image generating sections 38 and the left-eye image generating sections 40 may be arranged in an alternating manner in the vertical direction.

The optical element 28 includes a plurality of pixels that generate an image. The pixels are arranged two-dimensionally with a prescribed pitch in the vertical and horizontal directions. A pixel refers to a unit used in forming the image, and outputs color information concerning color tone and gradation. Each pixel includes three sub-pixels. Each sub-pixel includes a liquid crystal portion and transparent electrodes formed on the front and back surfaces of the liquid crystal portion. The transparent electrodes apply voltage to the liquid crystal portions. The liquid crystal portion of a sub-pixel to which voltage is applied has the polarization of the linearly polarized light emitted therefrom rotated by 90°. The three sub-pixels included in each pixel respectively include a red color filter, a green color filter, and a blue color filter. By controlling the voltage applied to the transparent electrodes of each sub-pixel, the red, green, and blue light emitted from the sub-pixels can be respectively strengthened or weakened to form an image.

The support substrate 30 is arranged between the optical element 28 and the polarizing plate 34. The support substrate 26 and the support substrate 30 sandwich and hold the optical element 28. The support substrate 30 can be realized by a transparent glass plate. Instead of using a glass plate, the support substrate 30 can be a transparent composite sheet that uses a transparent composite material including a glass fabric and a transparent resin. As a result, the stereoscopic image display apparatus 10 can be light-weight and have good flexibility. The front surface of the support substrate 30 supports the polarizing plate 34 via the adhesive layer 32.

The adhesive layer 32 is provided substantially uniformly on the entire front surface of the support substrate 30. The adhesive layer 32 can be realized using an acrylic adhesive agent. The adhesive layer 32 affixes the polarizing plate 34 to the front surface of the support substrate 30.

The polarizing plate 34 is arranged between the support substrate 30 and the phase shift plate 16. The polarizing plate 34 is affixed to the surface of the support substrate 30 on the opposite side of the surface supporting the optical element 28, by the adhesive layer 32. The polarizing plate 34 is formed by a resin containing polyvinyl alcohol (PVA). The thickness of the polarizing plate 34 is preferably low. The thickness of the polarizing plate 34 may be from 100 μm to 200 μm, for example. The polarizing plate 34 includes a transmission axis and an absorption axis that is orthogonal to the transmission axis. The transmission axis of the polarizing plate 34 is orthogonal to the transmission axis of the polarizing plate 22. Therefore, the linearly polarized light whose polarization axis is rotated 90° by the optical element 28 is transmitted by the polarizing plate 34 to serve as image light for forming an image. On the other hand, the linearly polarized light whose polarization axis is not rotated by the optical element 28 is blocked by the polarizing plate 34. As a result, the image output section 14 outputs image light having one polarization.

The phase shift plate 16 is affixed in front of the polarizing plate 34 of the image output section 14 by the adhesive layer 44. The phase shift plate 16 modulates the identical polarization states of the right-eye image and the left-eye image, which are formed by the linearly polarized light having polarization axes in the same direction, to each have a different polarization state. The thickness of the phase shift plate 16 is preferably low, in order to restrict dimensional change of the phase shift plate 16. Furthermore, the polarizing plate 34 is also preferably thin in order to restrict dimensional change thereof. Therefore, the dimensional change of the phase shift plate 16 can be further restricted. However, if the polarizing plate is thin and a thick phase shift plate is affixed to the polarizing plate using a hard adhesive layer, the effect of the dimensional change of the phase shift plate on the polarizing plate is increased. As a result, dimensional change of the phase shift plate causes greater dimensional change of the polarizing plate. Accordingly, these factors place a limit on how thin the polarizing plate 34 can be. Based on these factors, the thickness of the phase shift plate 16 is preferably from 50 μm to 200 μm. Regarding the relationship between the thickness of the phase shift plate 16 and the thickness of the polarizing plate 34, the phase shift plate 16 is preferably thinner than the polarizing plate 34. For example, if the phase shift plate 16 has a thickness of 50 μm, the thickness of the polarizing plate 34 is preferably approximately 100 μm. The phase shift plate 16 includes a plurality of phase shifting sections 46, a plurality of phase shifting sections 48, and a transparent substrate 50.

The adhesive layer 44 is provided substantially uniformly on the entire front surface of the polarizing plate 34. The hardness of the adhesive layer 44 is greater than or equal to the hardness of the adhesive layer 32. A material that includes UV-curable resin, for example, may be used to form the adhesive layer 44. The adhesive layer 44 affixes the phase shifting sections 46 and the phase shifting sections 48 in front of the polarizing plate 34.

The phase shifting sections 46 and the phase shifting sections 48 are arranged on the rear surface of the transparent substrate 50. The phase shifting sections 46 and the phase shifting sections 48 are arranged in the same vertical plane. The phase shifting sections 46 and the phase shifting sections 48 are arranged in an alternating manner in the vertical direction.

The phase shifting sections 46 are formed as strips that extend horizontally. The phase shifting sections 46 have substantially the same shape as the right-eye image generating sections 38 of the optical element 28. The phase shifting sections 46 are arranged in front of the right-eye image generating sections 38. The phase shifting sections 46 modulate the polarization state of the polarized light incident thereto. The phase shifting sections 46 are quarter-wave plates that convert linearly polarized light into circularly polarized light. The optical axis of each phase shifting section 46 is parallel to the vertical direction, as shown by the arrows at the left ends of the phase shifting sections 46 in FIG. 1. As a result, the phase shifting sections 46 modulate the incident linearly polarized light from the polarizing plate 34 to be right-handed circularly polarized light, as shown by the arrows to the right of the arrows representing the optical axes in FIG. 1. The optical axes may be fast axes or slow axes.

The phase shifting sections 48 are formed as strips that extend horizontally. The phase shifting sections 48 have substantially the same shape as the left-eye image generating sections 40 of the optical element 28. The phase shifting sections 48 are arranged in front of the left-eye image generating sections 40. The phase shifting sections 48 modulate the polarization state of the polarized light incident thereto. The phase shifting sections 48 are quarter-wave plates that convert linearly polarized light into circularly polarized light. The optical axis of each phase shifting section 48 is parallel to the horizontal direction, as shown by the arrows at the left ends of the phase shifting sections 48 in FIG. 1. As a result, the phase shifting sections 48 modulate the incident linearly polarized light from the polarizing plate 34 to be left-handed circularly polarized light, as shown by the arrows to the right of the arrows representing the optical axes in FIG. 1. Accordingly, the phase shifting sections 46 and the phase shifting sections 48 convert the linearly polarized light, which is the image light forming the right-eye image and the left-eye image, into circularly polarized light with different polarization axes, and emit the resulting light.

When viewing a stereoscopic image, the user puts on polarized glasses. The right-eye lens of the polarized glasses transmits right-handed circularly polarized light, which forms the right-eye image emitted from the phase shifting sections 46. The left-eye lens of the polarized glasses transmits left-handed circularly polarized light, which forms the left-eye image emitted from the phase shifting sections 48. Therefore, the right eye of the user sees only the circularly polarized light emitted from the right-eye image generating sections 38 and modulated by the phase shifting sections 46. Furthermore, the left eye of the user sees only the circularly polarized light emitted from the left-eye image generating sections 40 and modulated by the phase shifting sections 48. As a result, the user perceives a stereoscopic image.

The transparent substrate 50 used for the phase shift plate 16 according to the present embodiment can use a film made of a cyclic olefin addition polymer (copolymer) in which the copolymerization ratio of norbornene and ethylene is from 80:20 to 90:10, the melt volume rate (MVR) is from 0.8 cm³ to 2.0 cm³ per 10 minutes, and the glass transition temperature is from 170° C. to 200° C. By using such a film as the transparent substrate 50 of the phase shift plate 16, a phase shift film can be obtained that has excellent dimensional stability, mechanical and thermal endurance, and adhesion. Here, the melt volume rate (MVR) is a value indicating the fluidity of resin, obtained by drawing melted resin from a die while maintaining a prescribed temperature and load and then measuring the discharge capacity of the resin in a 10 minute calculation.

The anti-reflection film 18 is arranged on the front surface of the phase shift plate 16. The anti-reflection film 18 restricts reflection of the light emitted from the transparent substrate 50. Therefore, the anti-reflection film 18 can reduce the effect of light incident from the outside, and can therefore provide a highly accurate stereoscopic image.

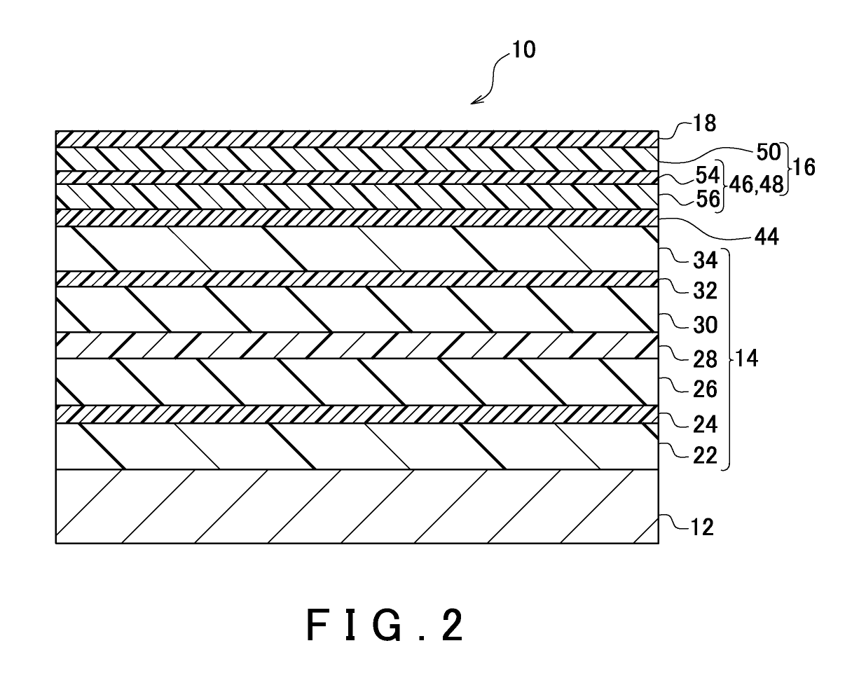

FIG. 2 is a cross-sectional view of the stereoscopic image display apparatus 10. As shown in FIG. 2, the phase shifting sections 46 each include an orientation layer 54 and a liquid crystal layer 56. The orientation layer 54 is formed over the entire rear surface of the transparent substrate 50. The orientation layer 54 may have a thickness from 20 nm to 30 nm, for example. The orientation layer 54 can be realized by an optical orienting compound that is widely known as an orienting agent. For example, the optical orienting compound may be a photolytic, optical double-quantum, or photoisomeric compound. The liquid crystal particles of the liquid crystal layer 56 are oriented to correspond to the orientation of the orientation layer 54. The orientations of the orientation layer 54 and the liquid crystal layer 56 correspond to the optical axes of the phase shifting sections 46 and the phase shifting sections 48. The liquid crystal layer 56 may have a thickness from approximately 1 μm to approximately 2 μm. Accordingly, the thickness of the orientation layer 54 and the liquid crystal layer 56 is less than the thickness of the transparent substrate 50, the adhesive layers 24, 32, and 44, the polarizing plates 22 and 34, and the like.

The following is a description of the operation of the stereoscopic image display apparatus 10 described above. First, in the stereoscopic image display apparatus 10, light is emitted forward from the light source 12. The emitted light is non-polarized, and there is a substantially uniform amount of light in the vertical plane. The light is incident to the polarizing plate 22 of the image output section 14. Here, the polarizing plate 22 has a transmission axis that is inclined by 45° from the horizontal direction and an absorption axis that is orthogonal to the transmission axis. Accordingly, the light is emitted form the polarizing plate 22 as linearly polarized light having a polarization axis that is parallel to the transmission axis of the polarizing plate 22.

The linearly polarized light emitted from the polarizing plate 22 is transmitted by the adhesive layer 24 and the support substrate 26 to be incident to the right-eye image generating sections 38 or the left-eye image generating sections 40 of the optical element 28. In the optical element 28, the voltage is applied to the sub-pixels corresponding to the image to be generated. The linearly polarized light transmitted through the sub-pixels to which voltage is applied has the polarization axis thereof rotated by 90°, and the resulting light is emitted from the optical element 28. On the other hand, the linearly polarized light that is transmitted through the sub-pixels to which voltage is not applied is emitted from the optical element 28 without having the polarization axis thereof rotated.

The linearly polarized light emitted from the optical element 28 is incident to the polarizing plate 34 after being transmitted through the support substrate 30 and the adhesive layer 32. Here, the transmission axis of the polarizing plate 34 is orthogonal to the transmission axis of the polarizing plate 22. Accordingly, the linearly polarized light whose optical axis is rotated 90° by the optical element 28 is transmitted by the polarizing plate 34. On the other hand, the linearly polarized light whose optical axis is not rotated by the optical element 28 is absorbed by the polarizing plate 34.

Among the linearly polarized light passed by the polarizing plate 34, the linearly polarized light emitted from the right-eye image generating sections 38 of the optical element 28 is incident to the phase shifting sections 46 of the phase shift plate 16. The phase shifting sections 46 have polarization axes in the vertical direction. Therefore, the linearly polarized light emitted from the right-eye image generating sections 38 is modulated to be right-handed circularly polarized light by the phase shifting sections 46, and is then emitted. On the other hand, among the linearly polarized light passed by the polarizing plate 34, the linearly polarized light emitted from the left-eye image generating sections 40 of the optical element 28 is incident to the phase shifting sections 48. The phase shifting sections 48 have polarization axes in the horizontal direction. Therefore, the linearly polarized light emitted from the left-eye image generating sections 40 is modulated to be left-handed circularly polarized light by the phase shifting sections 48, and is then emitted.

The circularly polarized light emitted from the phase shifting sections 46 and the phase shifting sections 48 is transmitted by the transparent substrate 50 and the anti-reflection film 18 to be emitted from the stereoscopic image display apparatus 10. The circularly polarized light is incident to the polarized glasses worn by the user. The right-eye lens of the polarized glasses worn by the user transmits the right-handed circularly polarized light, and the left-eye lens transmits the left-handed circularly polarized light. Therefore, the right-handed circularly polarized light is incident to the right eye of the user and the left-handed circularly polarized light is incident to the left eye of the user. As a result, the user can perceive a stereoscopic image.

The following describes a method for manufacturing the stereoscopic image display apparatus described above. First, the optical element 28 held between the transparent support substrate 26 and the support substrate 30 is manufactured. Next, the adhesive layer 24 is applied to the support substrate 26, and the polarizing plate 22 is then affixed to the support substrate 26 via the adhesive layer 24. Next, the adhesive layer 32 is applied to the support substrate 30, and the polarizing plate 34 is then affixed to the support substrate 30 via the adhesive layer 32. In this way, the polarizing plate 34 made of resin is affixed by the adhesive layer 32 to the side of the support substrate 30 that is opposite the side supporting the optical element 28. As a result, the image output section 14 that outputs image light having a single polarization is completed.

Next, the orienting agent is applied to the transparent substrate 50 and then dried to form the orientation layer 54. The transparent substrate 50 can use cyclic olefin copolymer (COC), which is a copolymer of cyclic olefin polymer. In particular, a film made of a norbornene and ethylene copolymer is preferable. An example of such a copolymer is TOPAS 6017 manufactured by TOPAS Advanced Polymers.

Next, the region of the orientation layer 54 corresponding to the phase shifting sections 46 is irradiated with linearly polarized light, such as UV light, and then the region of the orientation layer 54 corresponding to the phase shifting sections 48 is irradiated with linearly polarized light whose polarization axis is shifted by 90° relative to the polarization axis of the linearly polarized light used to irradiate the region of the orientation layer 54 corresponding to the phase shifting sections 46. As a result, the orientation layer 54 is obtained having a prescribed orientation. Next, a photopolymerizable liquid crystal composition is applied on the orientation layer 54 and hardened using drying or UV irradiation. As a result, the orientation of the liquid crystal composition is made to match the orientation of the orientation layer 54, thereby forming the liquid crystal layer 56 made of the phase shifting sections 46 and the phase shifting sections 48 on the transparent substrate 50. In this way, a phase shift plate 16 is completed that includes a plurality of phase shifting sections 46 and a plurality of phase shifting sections 48 that, when image light is incident thereto, respectively output circularly polarized light with polarization axes that are orthogonal to each other.

Next, the adhesive layer 44 is applied to the front surface of the polarizing plate 34 or to the rear surface of the phase shift plate 16. After this, the phase shift plate 16 is affixed to the polarizing plate 34 via the adhesive layer 44. In this state, the adhesive layer 44 is hardened by irradiating the adhesive layer 44 with UV rays. As a result, the phase shifting sections 46 and the phase shifting sections 48 of the phase shift plate 16 are affixed to the polarizing plate 34 of the image output section 14 by the adhesive layer 44. After this, the anti-reflection film 18 is provided on the phase shift plate 16 and the light source 12 is attached, thereby completing the stereoscopic image display apparatus 10.

In the embodiments described above, the phase shifting sections 46 and the phase shifting sections 48 output circularly polarized light with orthogonal polarization axes, but may instead output linearly polarized light with polarization axes that intersect.

### First Embodiment

A film using TOPAS 6017 was prepared as a transparent substrate. An orienting agent was applied on the transparent substrate using spin coating and then dried to form an orientation layer. Proximity exposure was performed on the orientation layer using a mask patterned to have a striped shape in a UV-polarized light exposure device. First, linearly polarized light was radiated to cause the orientation of the applied liquid crystal particles to become parallel to the length of the transparent substrate. Next, the mask was removed and linearly polarized light with a polarization direction orthogonal to the original exposure light was radiated. In this way, the orientation layer was formed to orient the liquid crystal particles in directions normal to and parallel to the length of the transparent substrate. A photopolymerizable liquid crystal composition was applied to the orientation layer using spin coating, thereby manufacturing, as a test sample, a quarter-wave plate in which the liquid crystal particles are oriented in each direction of the orientation layer. Finally, this test sample was diced into 20 cm squares to obtain the phase shift plate for testing.

The phase shift plate for testing was affixed to a prescribed LCD monitor, in a manner corresponding to the display pixels, via an adhesion sheet. After being left for 24 hours in an atmosphere with a temperature of 40° C. and 90% humidity, 3D display was performed and the naked eye was used to check for a twin image. The image viewed over the entire screen prior to being left for 24 hours was not significantly different than the image viewed after the 24 hours, and no twin image was observed. Furthermore, the phase shift plate did not peel away from the LCD monitor. Based on these results, it is understood that the phase shift plate made of the film using the TOPAS 6017 has excellent dimensional stability, thermal endurance, and adhesion.

### Comparative Example 1

A film using triacetylcellulose was prepared as a transparent substrate. A phase shift plate for testing was manufactured as a 20 cm square using this transparent substrate, according to the method described in the First Embodiment. This phase shift plate for testing was affixed to a prescribed LCD monitor, in a manner corresponding to the display pixels, via an adhesion sheet. After being left for 24 hours in an atmosphere with a temperature of 40° C. and 90% humidity, 3D display was performed and the naked eye was used to check for a twin image, in the same manner as above. Twin images were seen in the upper and lower portions of the screen, and correct 3D display could not be achieved. Furthermore, the phase shift plate was observed to have peeled off at the edges of the LCD monitor.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

What is claimed is:

1. A phase shift plate comprising:
a transparent substrate;
an orientation layer that is formed on one surface of the substrate and that includes anisotropic polymers with orientation direction patterns arranged periodically along a primary surface of the substrate; and
a liquid crystal layer that includes liquid crystals that are periodically oriented according to the orientation direction of the orientation layer, wherein
the transparent substrate is formed by a cyclic olefin copolymer made of a norbornene and ethylene copolymer.

2. A stereoscopic image display apparatus comprising:
an image generating section that includes a right-eye image generating region for generating a right-eye image and a left-eye image generating region for generating a left-eye image;
an image display section that emits right-eye image light including the right-eye image and left-eye image light including the left-eye image as linearly polarized light having the same polarization axis; and
a phase shift plate that includes a first polarization region and a second polarization region and that, when the right-eye image light and the left-eye image light are respectively incident to the first polarization region and the second polarization region, emits the incident right-eye image light and left-eye image light respectively as linearly polarized light having polarization axes orthogonal to each other or as circularly polarized light having polarization axes rotated in opposite directions, wherein
the phase shift plate is the phase shift plate according to claim 1.
